(19) United States
(12) Patent Application Publication
(10) Pub. No.: US 2005/0031189 A1
(43) Pub. Date: Feb. 10, 2005

(54) Method for the inspection of features on semiconductor substrates

(75) Inventor: Jorg Richter, Gladenbach-Weidenhausen (DE)

Correspondence Address: FOLEY AND LARDNER;SUITE 500, 3000 K STREET NW, WASHINGTON, DC, 20007, US

(73) Assignee: LEICA MICROSYSTEMS SEMICONDUCTOR GmbH

(21) Appl. No.: 10/886,596

(22) Filed: Jul. 9, 2004

(30) Foreign Application Priority Data
Jul. 11, 2003 (DE) 103 31 594.2

(51) Int. Cl. G06K 9/00

(52) U.S. Cl. 382/145

(57) ABSTRACT

A method for the inspection of features of semiconductor substrates is disclosed. Once an image of a semiconductor substrate has been acquired, ROIs are allocated to pattern elements. Various parameters for evaluation of the acquired image of the semiconductor substrate are assigned to the ROIs. The ROI assigned to one pattern element of the semiconductor substrate is automatically transferred to corresponding pattern elements of the semiconductor substrate in the other elements.

### CROSS REFERENCE TO RELATED APPLICATIONS

This application claims priority of the German patent application 103 31 594.2 which is incorporated by reference herein.

### FIELD OF THE INVENTION

The invention concerns a method for the inspection of features on semiconductor substrates.

### BACKGROUND OF THE INVENTION

In semiconductor manufacturing, wafers are sequentially processed in a plurality of process steps during the manufacturing process. With increasing integration density, requirements in terms of the quality of the features configured on the wafers become more stringent. To allow the quality of the configured features to be checked, and any defects to be found, a corresponding requirement exists in terms of the quality, accuracy, and reproducibility of the components and process steps used on the wafers. This means that during production of a wafer, with the many process steps and many layers of photoresist, or the like, to be applied, early and reliable detection of defects in the individual features is particularly important. A plurality of identical recurring pattern elements are provided on a patterned semiconductor substrate or wafer. As a result of the patterning, a different brightness of the acquired image is seen in each of the various regions. A definition is then made of multiple rectangular regions (regions of interest, ROIs) that can be defined independently from one another in terms of detection sensitivity. The sensitivity used for detection is a factor of a baseline sensitivity and the sensitivity defined for the region. Regions can be defined both within dice and also in terms of a stepper area window (SAW). In the first case, the described region is transferred to all other dice. In the second case, the region is valid only once within a SAW, but is transferred to all other SAWs.

### SUMMARY OF THE INVENTION

It is the object of the invention to create a method with which the detection sensitivity for pattern elements on a patterned semiconductor substrate can be adapted by a user.

This object is achieved by a method for the inspection of features on semiconductor substrates, comprising the following steps:

acquiring an image of at least one semiconductor substrate, that image encompassing a plurality of elements that have identical recurring features;
allocating at least one ROI to a pattern element in a single element, the ROI having assigned to it various parameters for evaluation of the acquired image of the semiconductor substrate;
automatically transferring that ROI to corresponding pattern elements of the semiconductor substrate in the other elements.
   It is particularly advantageous if firstly an image of at least one semiconductor substrate is acquired, that image encompassing a plurality of elements that have identical recurring features. The user allocates at least one region of interest (ROI) to a pattern element, the allocation being accomplished in a single element. Various parameters for evaluation of the acquired image of the semiconductor substrate are assigned to the ROI. The ROI thus identified is automatically transferred to corresponding pattern elements of the semiconductor substrate in the other elements, the parameters assigned to the ROI also being transferred. Inspection is applied to all elements of the semiconductor substrate in accordance with the parameters assigned to the at least one ROI. On the one hand, the patterned semiconductor substrate defines several SAWs, each SAW separately encompassing several dice, and the pattern element being a SAW.
   In another embodiment of the invention, the pattern element is part of a die. Each SAW of a semiconductor substrate encompasses multiple dice.
   It is particularly advantageous if at least two ROIs are selected in one die. The method can moreover also work with ROIs that overlap. At least two ROIs must therefore be present. Inspection of the at least two overlapping regions is performed by applying the parameters of the ROI that was most recently defined.
   The various ROIs for the inspection of features on semiconductor substrates are defined by the user and are surrounded by a border. The user can also, by appropriate parameter input, distribute the detection weighting among the various ROIs.

### BRIEF DESCRIPTION OF THE DRAWINGS

The subject matter of the invention is depicted schematically in the drawings and will be described below with reference to the Figures, in which:

FIG. 1 schematically depicts a system for detecting faults on wafers or patterned semiconductor substrates;

FIG. 2a depicts the manner in which the images or image data of a wafer are acquired;

FIG. 2b is a schematic plan view of a wafer;

FIG. 3 shows a logically segmented SAW;

FIG. 4 shows an image field of a camera showing imageable logical SAW segments;

FIG. 5 shows one possibility for selecting and arranging at least two ROIs;

FIG. 6 shows a portion of a patterned semiconductor substrate or wafer in which the die-based ROIs are marked; and

FIG. 7 shows a portion 40 of a patterned semiconductor substrate or wafer in which SAW-based ROIs are determined.

### DETAILED DESCRIPTION OF THE INVENTION

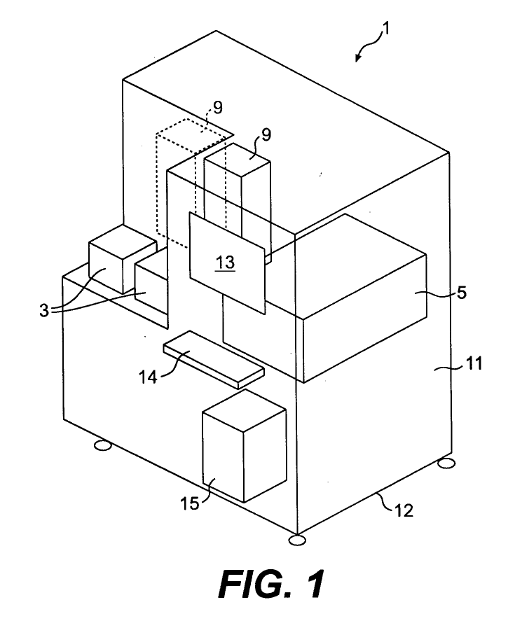

FIG. 1 shows a system 1 for the inspection of features on semiconductor substrates. System 1 comprises, for example, at least one cassette element 3 for the semiconductor substrates or wafers. In a measurement unit 5, images or image data of the individual wafers or patterned semiconductor substrates are acquired. A transport mechanism 9 is provided between cassette element 3 for the semiconductor substrates or wafers and measurement unit 5. System 1 is enclosed by a housing 11, housing 11 defining a base outline 12. Also integrated into system 1 is a computer 15 that receives and processes the images or image data of the individual measured wafers. System 1 is equipped with a display 13 and a keyboard 14. By means of keyboard 14, the user can input data in order to control system 1, or can also make parameter inputs in order to evaluate the image data of the individual wafers. On display 13, several user interfaces are displayed to the user of the system. On the user interface, the user additionally has the capability of inputting parameters and positioning a region of interest (ROI).

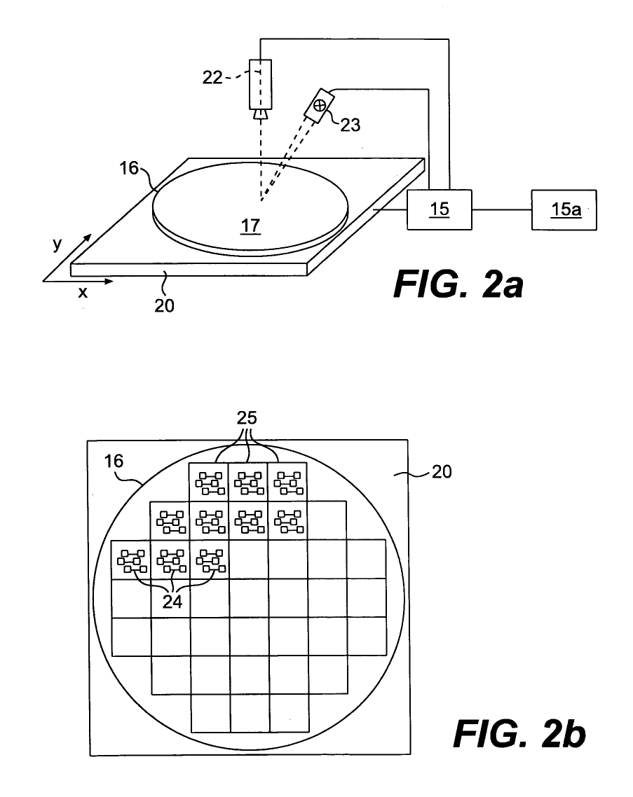

FIG. 2a is a schematic view of the manner in which images and/or image data of a wafer 16 are sensed. Wafer 16 is placed on a stage 20 that is movable in housing 11 of system 1 in a first direction X and a second direction Y. First and second direction X, Y are arranged perpendicular to one another. An image acquisition device 22 is provided above surface 17 of wafer 16, the image field of image acquisition device 22 being smaller than the entire surface 17 of wafer 16. In order to sense the entire surface 17 of wafer 16 with image acquisition device 22, wafer 16 is scanned in meander fashion. The successively sensed individual image fields are assembled into an overall image of surface 17 of a wafer 16. This is done also using computer 15 provided in housing 11. In order to produce a relative motion between stage 20 and image acquisition device 22, an X-Y scanning stage that can be displaced in the coordinate directions X and Y is used in this exemplary embodiment. Image acquisition device 22 is here installed immovably with respect to stage 20. Conversely, of course, stage 2 can also be installed immovably, and image acquisition device 22 can be moved over wafer 16 in order to acquire images. Also possible is a combination of motion of image acquisition device 22 in one direction and of stage 20 in the direction perpendicular thereto. A variety of systems can be used as image acquisition devices 22. On the one hand, both area cameras and linear cameras, which create microscopic or macroscopic images, can be used. The resolution of the camera is generally coordinated with the imaging optical system, e.g. the objective of a microscope or macroscope. For macroscopic images, the resolution is e.g. 50 μm per pixel.

Wafer 16 is illuminated with an illumination device 23 which illuminates at least regions on wafer 16 that correspond to the image field of image acquisition device 22. The concentrated illumination, which moreover can also be pulsed with a flash lamp, allows images to be acquired on the fly, i.e. with stage 20 or image acquisition device 22 being displaced without stopping to acquire the image. This allows a high wafer throughput. It is also possible, of course, to stop the relative motion between stage 20 and image acquisition device 22 for each image acquisition, and also to illuminate wafer 16 over its entire surface 17. Stage 20, image acquisition device 22, and illumination device 23 are controlled by computer 15. The acquired images can be stored by computer 15 in a memory 15a, and also retrieved again therefrom as necessary. As a rule, the wafer is moved beneath image acquisition device 22. It is also conceivable, however, for image acquisition device 22 to be moved relative to the wafer. This motion is continuous. The individual images are achieved by the fact that a shutter is opened and a corresponding flash is triggered. The flash is triggered as a function of the relative position of the wafer, which is reported by way of corresponding position parameters of the stage that moves the wafer.

FIG. 2b shows a plan view of a wafer 16 that is placed onto a stage 20. Layers are applied onto wafer 16 and are then patterned in a further operation. A patterned wafer encompasses a plurality of elements 25 that, as a rule, comprise features 24 that are identical and recur in all elements 25.

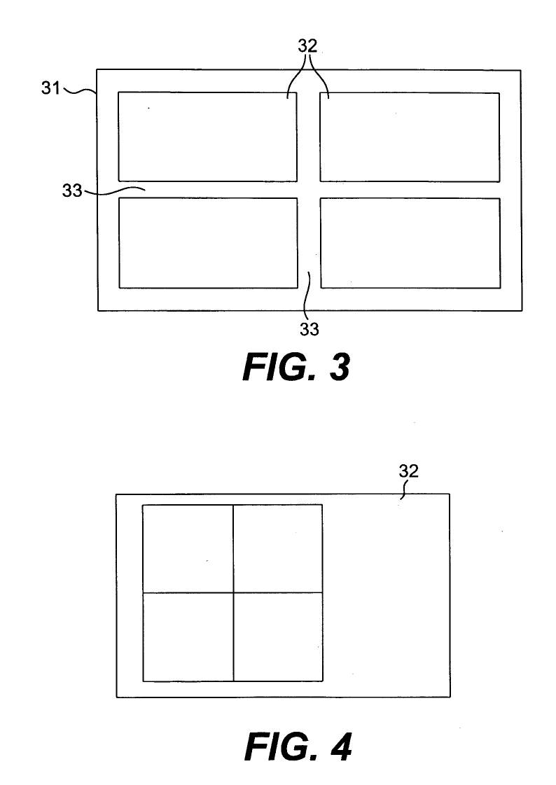

FIG. 3 shows a SAW 31 that is subdivided into segments 32. In an initializing step (also called the programming step), the image field of the camera is subdivided into SAW-segment-imaging image field segments, preferably by way of an interactive control system (PC screen, keyboard, and mouse), in such a way that after a definable interval of acquired images, a repetition occurs of an identical allocation of imaged SAW segments to image field segments. This selected interval should not be too great. If a minimum interval is desired, a corresponding optimization can be performed automatically by the system. This is also conceivable for other spacings. Known optimization algorithms, e.g. interval halving, are conceivable. This initialization phase is executed only once for a wafer type. Once initialization has occurred, only the comparison operations are performed after the image data have been read in; in those operations, the image field segments of images that have an identical allocation of image field segments to imaged SAW segments are compared with one another. The SAW in turn contains several dice 33. Subdivision of the SAW into logical SAW segments is performed in such a way that the sizes of the respective SAW segments and image field segments are identical.

It has proven to be advantageous to subdivide the SAW into logical SAW segments of preferably identical size.

FIG. 4 shows an image portion 15 that comprises four image field segments. A patterned semiconductor wafer comprises dies 32 and “streets” 34 located between the dies 32. A certain number of dice are exposed simultaneously using a stepper. The region that is exposed in one shot or one image acquisition is called a stepper area window (SAW). Since all the SAWs on a semiconductor wafer are exposed using the same mask, all the features other than dice 32 are also at the same location in each SAW. It is conceivable in principle for different dice to be accommodated in one SAW. The known approach of comparing adjacent dice to one another is thus not advisable.

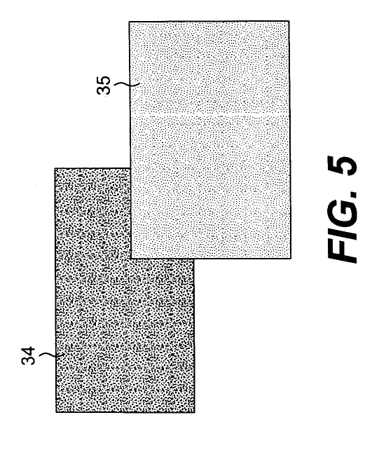

FIG. 5 shows one possibility for selecting and arranging at least two ROIs. A first ROI 34 and a second ROI 35 can, in this context, overlap. In this case the sensitivity of the ROI that was most recently defined applies to an overlap region 36. Here, for example, second ROI 35 was the last one defined, so that the sensitivity of second ROI 35 applies to the entire area occupied by the second ROI.

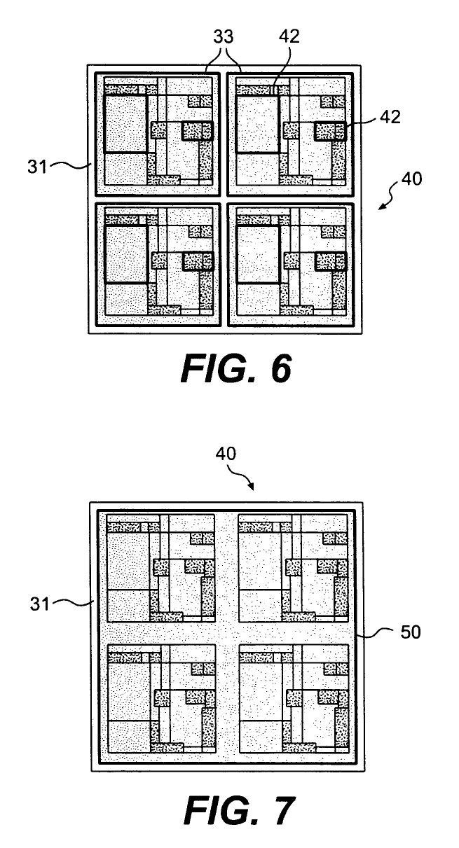

FIGS. 6 and 7 show a portion 40 of a patterned semiconductor substrate or wafer 16. In the context of automatic inspection of features on semiconductor substrates using image-processing software, it may be useful to set certain regions within a portion 40 to a higher or lower sensitivity. This is done in FIG. 7 by surrounding the features of interest with a border 42. As already mentioned above, the user can input the border using keyboard 14 or a mouse (not depicted). The user can thereby direct the detection weighting toward specific regions (ROIs), or also exclude them entirely from detection. The sensitivity for each defined ROI of a SAW 31 can be inputted as a percentage of the baseline sensitivity. Any subsequent modification of the baseline sensitivity thus also results in a correction of the sensitivities of the ROIs. The embodiment depicted in FIG. 6 refers to die-based ROIs that are placed within or determined in on die 33. The ROIs defined in one die 33 are transferred to all other dice 33, and treated identically when the acquired images are detected and evaluated.

In FIG. 7, a SAW-based ROI 50 has been determined. ROI 50 and its allocated parameters for evaluation of the acquired images are transferred to all other SAWs 31 on the patterned semiconductor substrate.

1. A method for the inspection of features on semiconductor substrates, comprising the following steps:
acquiring an image of at least one semiconductor substrate, that image encompassing a plurality of elements that have identical recurring features;
allocating at least one ROI to a pattern element in a single element, the ROI having assigned to it various parameters for evaluation of the acquired image of the semiconductor substrate;
automatically transferring that ROI to corresponding pattern elements of the semiconductor substrate in the other elements.

2. The method as defined in claim 1, wherein inspection is applied to all elements of the semiconductor substrate in accordance with the parameters assigned to the at least one ROI.

3. The method as defined in claim 1, wherein the patterned semiconductor substrate defines several SAWs that each separately encompass several dies; and the pattern element is a SAW.

4. The method as defined in claim 1, wherein the patterned semiconductor substrate defines several SAWs that each separately encompass several dies; and the pattern element is part of a die.

5. The method as defined in claim 4, wherein at least two ROls are selected in one die.

6. The method as defined in claim 5, wherein at least two ROIs have an overlap region.

7. The method as defined in claim 6, wherein inspection of the at least two overlapping regions is performed in such a way that the parameters of the ROI that was defined most recently are applied to the overlap region.

8. The method as defined in any of claims 1 through 7 claim 1, wherein the various ROIs for the inspection of semiconductor substrates are defined by the user and surrounded by a border; and the user likewise, by suitable parameter input, distributes the detection weighting among the various ROIs.

9. The method as defined in claim 8, wherein the parameter input is entered as a percentage of the baseline sensitivity.

10. The method as defined in claim 2, wherein the various ROIs for the inspection of semiconductor substrates are defined by the user and surrounded by a border; and the user likewise, by suitable parameter input, distributes the detection weighting among the various ROIs.

11. The method as defined in claim 3, wherein the various ROIs for the inspection of semiconductor substrates are defined by the user and surrounded by a border; and the user likewise, by suitable parameter input, distributes the detection weighting among the various ROIs.

12. The method as defined in claim 4, wherein the various ROIs for the inspection of semiconductor substrates are defined by the user and surrounded by a border; and the user likewise, by suitable parameter input, distributes the detection weighting among the various ROIs.

13. The method as defined in claim 5, wherein the various ROIs for the inspection of semiconductor substrates are defined by the user and surrounded by a border; and the user likewise, by suitable parameter input, distributes the detection weighting among the various ROIs.

14. The method as defined in claim 6, wherein the various ROIs for the inspection of semiconductor substrates are defined by the user and surrounded by a border; and the user likewise, by suitable parameter input, distributes the detection weighting among the various ROIs.

15. The method as defined in claim 7, wherein the various ROIs for the inspection of semiconductor substrates are defined by the user and surrounded by a border; and the user likewise, by suitable parameter input, distributes the detection weighting among the various ROIs.
